(19) United States
(12) Patent Application Publication
(10) Pub. No.: US 2025/0151682 A1
(43) Pub. Date: May 15, 2025

(54) PLANT TRANSPLANTATION PROCESS AND SYSTEM

(71) Applicant: PURE IMPACT FZCO, Dubai (AE)

(72) Inventor: Huseyin Cenk YABAS, Dubai (AE)

(21) Appl. No.: 18/838,619

(22) PCT Filed: Feb. 15, 2022
(86) PCT No.: PCT/IB2022/051311

§ 371 Date: Aug. 15, 2024

(51) Int. Cl. A01G 31/04; A01G 31/02; A01G 31/06

(52) U.S. Cl. CPC A01G 31/042; A01G 31/024; A01G 31/06

(57) ABSTRACT

There is disclosed a plant multiple transplantation process including the steps of transporting a plurality of trays holding growing plants from a grow room to a processing room, the plurality of trays being stacked on multiple layers of vertical shelves located in the grow room; transplanting the growing plants from densely packed trays transported from the grow room to less densely packed trays in comparison with the densely packed tray in the processing room; and transporting the transplanted plants back to the grow room in the less densely packed trays to continue growing until the transplanted plants outgrow the less densely packed trays, subsequent to which the plurality of trays are transported back to the processing room for another round of transplantation. Also disclosed is a system comprising a first robotic apparatus positioned in a processing room, and a second robotic apparatus positioned in the growth room.

### FIELD OF THE INVENTION

The present invention relates to the field of plant transplantation, and more particularly to a plant transplantation process and system.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

Traditionally performed transplanting methods have multiple drawbacks and lead to deterioration of the plants or roots. Further, the robotic arms used in farming environments are not suitable for transplanting plants as damage to roots is inevitable, and multiple transplanting is an impossible task with traditional robots/even manual labor. Increased human intervention or manual labor leads to plant deterioration and also result in expensive maintenance costs. Another disadvantage with traditional farming methods is that large acres of land or area are required for farming/cultivation, which is not always practical and feasible.

There are previously implemented farming systems using trays filled with water which are transported manually (with human intervention) and the overall process is extremely time consuming, and requires a team of individuals. Manual transplanting also poses health risks to individuals transporting the plants, such as muscle or ligament strain. Additionally, it is difficult to maintain optimum spacing and uniform plant density with random transplanting and transplant contracting. Transplant contracting also tends to have lower plant density on an area basis, which results in lower yields.

Traditional farming methods tend to expose crops to extreme weather conditions, or other geological and climate hazards. Extreme heat stress, even with adequate soil moisture, can cause a reduction in plant stomatal conductance, which reduces plant transpiration rate and can cause great reductions in plant productivity and yield. Extreme cold decreases plant enzyme activity, which disrupts plant nutrient intake, causing stunted growth or death of the plant. Thus, traditional farming methods are not optimal for providing regular and healthy harvests. Traditional farming and transplanting methods also require a large volume of freshwater to maintain healthy crops, as much of the water is absorbed into the ground or evaporates before the plants absorb it. Furthermore, fertilization methods and use of pesticides in traditional farming techniques have many disadvantages. Fertilizers and chemicals used to keep plants free from pests, including herbicides and pesticides, can leech into the ground, or runoff into water supply.

Accordingly, there exists a need for a plant transplantation system, which overcomes drawbacks of traditionally employed growing techniques and/or systems.

### SUMMARY OF THE INVENTION

Therefore it is an object of the present invention to develop a plant transplantation system and process, which overcomes drawbacks of traditionally employed growing techniques and/or systems.

There is disclosed a plant multiple transplantation process, the process comprising the steps of transporting a plurality of trays holding growing plants from a grow room to a processing room, the plurality of trays being stacked on multiple layers of vertical shelves located in the grow room; transplanting the growing plants from densely packed trays transported from the grow room to less densely packed trays in comparison with the densely packed tray in the processing room; and transporting the transplanted plants back to the grow room in the less densely packed trays to continue growing until the transplanted plants outgrow the less densely packed trays, subsequent to which the plurality of trays are transported back to the processing room for another round of transplantation.

In an embodiment of the present invention, transplanting the growing plants from the densely packed trays arriving from the grow room comprises emptying the densely packed trays and moving the growing plants to the less densely packed trays; and disinfecting the emptied trays prior to reloading with new seedlings or plants.

In another embodiment of the present invention, disinfecting the emptied trays comprises cleaning and disinfecting the emptied trays, which is performed at a disinfection area in the processing room.

In another embodiment of the present invention, the plant multiple transplantation process further comprises transporting the cleaned emptied trays to a nursery area; and loading the cleaned emptied trays with new seedlings.

In another embodiment of the present invention, an entry side transport robot facilitates placing of the plurality of trays coming from the processing room on the plurality of vertical shelves in the grow room, and an exit side transport robot facilitates picking up of the plurality of trays from the plurality of vertical shelves in the grow room to the processing room for transplantation.

In another embodiment of the present invention, the entry side and exit side transport robots are Cartesian robots which move along x and y-axes.

In another embodiment of the present invention, growing plants which reach full growth or a 35-day lifetime are transported to a packaging center to be packed and sent to market, or to be further grown outdoors in a crop field or open space, instead of being transported back to the grow room.

In another embodiment of the present invention, the growing plants are positioned within holes of the plurality of trays, with minimum empty spaces between the growing plants for achieving optical efficiency and for adequate area utilization.

In another embodiment of the present invention, each of the growing plants are positioned within holes of the plurality of trays such that roots of the growing plants are constantly in direct contact with a film of liquid present at a bottom of the plurality of trays.

In another embodiment of the present invention, the liquid is water or a nutrient solution.

In another embodiment of the present invention, the plurality of trays comprise 16 holes per m2, 32 holes per m2, 64 holes per m2, 128 holes per m2 or 256 holes per m2.

In another embodiment of the present invention, transplanting the growing plants from densely packed trays to less densely packed trays in comparison with the densely packed tray is done using at least one robotic arm and at least two conveyor belts positioned in the processing room.

As another aspect of the present invention, a plant multiple transplantation system comprising a first robotic apparatus positioned in a processing room, for picking up and placing growing plants from densely packed trays arriving from a grow room to less densely packed trays in comparison to the densely packed trays for transplantation of the said plants; and a second robotic apparatus positioned in the growth room, for placing of the less densely packed trays comprising transplanted plants coming from the processing room in the grow room, and for picking up of the trays from the grow room to the processing room for further transplantation, once the transplanted plants outgrow the less densely packed trays.

In another embodiment of the present invention, the first robotic apparatus is an articulated robotic arm.

In another embodiment of the present invention, the second robotic apparatus is a Cartesian transport robot.

In another embodiment of the present invention, transplanting the growing plants from densely packed trays to less densely packed trays in comparison with the densely packed tray is done using at least one robotic arm and at least two conveyor belts positioned in the processing room.

In another embodiment of the present invention, the plant multiple transplantation system further comprises, emptying the densely packed trays by moving the growing plants to the less densely packed trays; and a disinfection area for disinfecting the emptied trays prior to reloading with new seedlings.

In another embodiment of the present invention, the plant multiple transplantation system further comprises a nursery where the cleaned emptied trays are transported to; for loading the cleaned emptied trays with new seedlings.

In another embodiment of the present invention, trays filled with growing plants are transported from the grow room to the processing room, and vice-versa in a continuous fashion for multiple transplantation to be done.

In another embodiment of the present invention, the trays filled with growing plants are positioned on a plurality of vertical shelves located in the grow room, until a next round of transplantation is required.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 shows a top-view depiction of the proposed transplantation system, in accordance with the present invention.

FIG. 2 is a perspective view of the proposed transplantation system, in accordance with the present invention.

FIGS. 3, 4A and 4B illustrate the robotic arms used in accordance with the present invention including a plurality of extensions or fingers (grippers) at the end of the robotic arms.

FIG. 5 is a flow chart depicting overall functioning of the articulated robotic arms used for transplantation.

FIG. 6A-6C shows the Cartesian transport robots (entry and exit side robots), in accordance with the present invention.

FIG. 7 is a flow chart depicting functioning of the Cartesian transport robots 106, in accordance with the present invention.

FIG. 8 shows a plurality of specialized vertical shelves with multiple layers for vertical farming, in accordance with the present invention.

FIG. 9 depicts a curvature or C shaped portion at the upper portion of the shelf layers, in accordance with the present invention.

FIG. 10 shows the trays in accordance with the present invention with holes in varying numbers/densities (however preferably in multiples of 4).

FIG. 11 shows a tray with 16 holes per m2 (FIG. 11A), a tray with 32 holes per m2 (FIG. 11B), a tray with 64 holes per m2 (FIG. 11C), a tray with 128 holes per m2 (FIG. 11D) and a tray with 256 holes per m2 (FIG. 11E).

FIG. 12 depicts how each tray is placed aptly on each of the vertical shelf layers, in accordance with the present invention.

FIGS. 13A, 13B, 14A and 14B shows how the seedlings or plants are placed within cups and rooted within an insulation material, in accordance with the present invention.

FIG. 15A-C show three different types of cups used for the seedlings or plants in the trays, in accordance with the present invention.

### DETAILED DESCRIPTION OF THE INVENTION

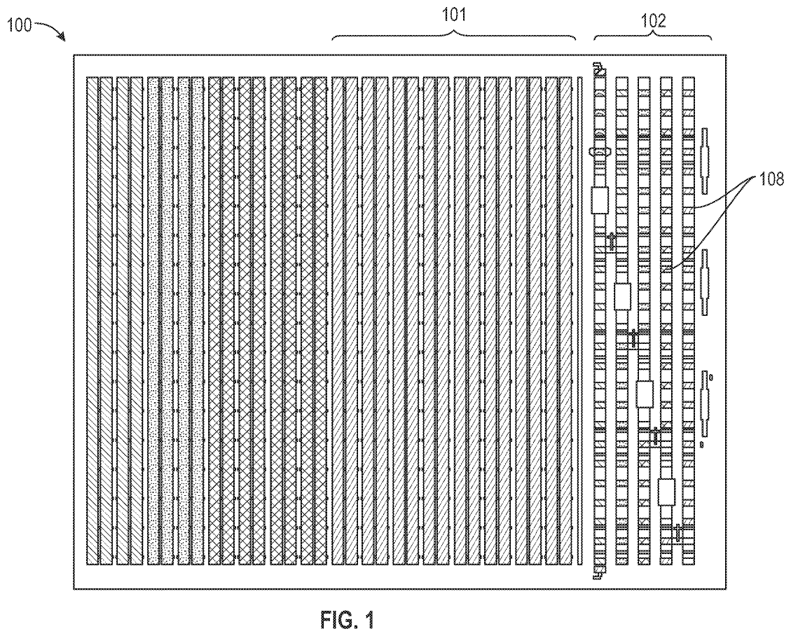

The aspects of the proposed plant transplantation process and system, according to the present invention will be described in conjunction with FIGS. 1-15. In the Detailed Description, reference is made to the accompanying figures, which form a part hereof, and in which is shown by way of illustration specific embodiments in which the invention may be practiced. It is to be understood that other embodiments may be utilized and logical changes may be made without departing from the scope of the present invention. The following detailed description, therefore, is not to be taken in a limiting sense, and the scope of the present invention is defined by the appended claims.

A major objective of the proposed invention is to decrease overall harvesting time and to increase overall yield, using vertical farming. Further, the benefits of multiple transplantation of plants include healthier roots, better crop production, stronger and healthier plants. Traditionally implemented systems fail to allow for multiple transplantation without affecting root health, and this problem is effectively solved by the present invention. Traditionally implemented systems fail to allow for multiple transplantation without affecting root health, and this problem is effectively solved by the present invention. The benefits of vertical farming include reliable year-round crop production, unaffected by adverse weather conditions, better use of space, minimum water usage, minimum to zero use of chemicals or pesticides, and being highly energy efficient. Accordingly, it is an objective of the present invention to propose a process and system for plant transplantation using robotic arms for efficiently transplanting a plurality of plants or seedlings positioned within a plurality of holes of a transplanting tray. Each of the trays carries a film of water (or nutrient solution) at the base, and roots of the plants are submerged in this water at all times. In case of being only a film of liquid (water or nutrient solution)—the roots have continuous access to the liquid, however the roots are not immersed in the same at all times which promotes healthier roots (and prevents wearing away of roots owing to presence of too much water).

Traditionally implemented robotic arms in farming environments are not suitable for transplanting plants as damage to roots is inevitable, and multiple transplanting is an impossible task with traditional robots or even manual labor. Increased human intervention or manual labor which leads to plant deterioration, and also leads to expensive maintenance costs. Accordingly, an objective of the present invention is to achieve efficient transplanting of seedlings or plants and to ensure equal spacing between all plants and minimum empty spaces between the plants (thereby saving land/lighting area helping in reducing energy consumptions). The plants are positioned within holes of the trays—with minimum empty spaces between them for achieving energy or optical efficiency and adequate land or area utilization.

FIG. 1 shows a top-view depiction of the proposed transplantation system 100, in accordance with the present invention. Various shelf sets A-D are shown located in a grow room or growth area 101, each holding a plurality of transplanting trays 108. An adjacent portion of the proposed transplantation system 100 includes a processing room or processing area 102 comprising a plurality of conveyor belts for transporting the transplanting trays 108 as well as a plurality of robotic arms, which assist in the transplanting process. Seedlings or baby plants are initially positioned within holes of the trays and are kept in a nursery or observation area (not shown) for the first 10 days of their life-cycle. After reaching 10 days of maturity—the plants (positioned within holes of the trays) are transported to a first set of vertical shelves (shelf set A, which is a set of 2-3 vertical shelves with a plurality of layers each) located at a first end of the grow room 101. Cartesian robots (transport robots) 106 are used in the grow room 101, operatively positioned on either sides of the vertical shelves 104—specifically an entry side robot 106a and an exit side robot 106b, for carrying and/or transporting the plant trays 108. The entry side transport robot 106a pushes and drops the plant trays 108 onto each layer of the vertical shelf 104, and the exit side transport robot 106b pulls the plant trays outwards and assists in transporting the plant trays 108 to the next position (most likely to the processing room 102).

Once the plants reach 20 days of their life-cycle, the specific plant trays are pulled out (by the exit side transport robot 106b) and transported to the processing room 102—for the transplantation procedure. Accordingly, trays carrying the 20 day plants are placed onto a conveyor belt 103, moves along the conveyor belt 103 and reaches a transplantation robot (articulated robotic arm apparatus) 110. In the processing room (or transplantation room) 102, these 20 day plants are taken out of their present trays (by the transplantation robotic arm 110) and transferred to another set of trays comprising holes more spaced apart from each other than the previous trays, or in other words—the 20 day plants are transplanted to another set of trays at a density of approximately 256 plants per square meter, ensuring primarily minimum empty spaces (thereby ensuring maximum space utilization) between the plants, and also allowing sufficient space for the plants to grow and breathe. The now transplanted 20 day plants are then transported back to the grow room 101 by the entry side transport robot 106a, and dropped onto layers of a second set of vertical shelves (shelf set B, which is a set of 2-3 vertical shelves with a plurality of layers each) located next to shelf set A.

Once the plants reach 25 days of their life-cycle, the specific plant trays are pulled out (by the exit side transport robot 106b) and transported to the processing room 102—for the transplantation procedure. Accordingly, trays carrying the 25 day plants are placed onto the conveyor belt 103, move along the conveyor belt 103 and reach another transplantation robot (articulated robotic arm apparatus) 110. In the processing room (or transplantation room) 102, these 25 day plants are taken out of their present trays (by the transplantation robotic arm 110) and transferred to another set of trays comprising holes more spaced apart from each other than the previous trays, or in other words—the 25 day plants are transplanted to another set of trays at a density of approximately 128 plants per square meter, ensuring primarily minimum empty spaces (thereby ensuring maximum space utilization) between the plants, and also allowing sufficient space for the plants to grow and breathe. The now transplanted 25 day plants are then transported back to the grow room 101 by the entry side transport robot 106a, and dropped onto layers of a third set of vertical shelves (shelf set C, which is a set of 4-6 vertical shelves with a plurality of layers each) located next to shelf set B.

Once the plants reach 30 days of their life-cycle, the specific plant trays are pulled out (by the exit side transport robot 106b) and transported to the processing room 102—for the transplantation procedure. Accordingly, trays carrying the 30-day plants are placed onto the conveyor belt 103, move along the conveyor belt 103 and reach another transplantation robot (articulated robotic arm apparatus) 110. In the processing room (or transplantation room) 102, these 30 day plants are taken out of their present trays (by the transplantation robotic arm 110) and transferred to another set of trays comprising holes more spaced apart from each other than the previous trays, or in other words—the 30 day plants are transplanted to another set of trays at a density of approximately 64 plants per square meter, ensuring primarily minimum empty spaces (thereby ensuring maximum space utilization) between the plants, and also allowing sufficient space for the plants to grow and breathe. The now transplanted 30 day plants are then transported back to the grow room 101 by the entry side transport robot 106a, and dropped onto layers of a fourth and final set of vertical shelves (shelf set D, which is a set of 8-10 vertical shelves with a plurality of layers each) located next to shelf set C.

Once the plants reach approximately 35 days of their life-cycle, the specific plant trays are pulled out (by the exit side transport robot 106b) and transported to the processing room 102—for the transplantation procedure. Accordingly, trays carrying the 35-day plants are placed onto the conveyor belt 103, move along the conveyor belt 103 and reach another transplantation robot (articulated robotic arm apparatus) 110. In the processing room (or transplantation room) 102, these 35-day plants are taken out of their present trays (by the transplantation robotic arm 110) and transferred to another set of trays comprising holes more spaced apart from each other than the previous trays, or in other words—the 35-day plants are transplanted to another set of trays at a density of approximately 32 plants per square meter, ensuring primarily minimum empty spaces (thereby ensuring maximum space utilization) between the plants, and also allowing sufficient space for the plants to grow and breathe. The now transplanted 35-day plants are then transported either to a packaging center 113 (to be packed and sent to the market), or to be further grown outdoors in a crop field or any such open space. Trays filled with growing plants are positioned on a plurality of vertical shelves located in the grow room, until a next round of transplantation is required.

In other words, a plant multiple transplantation process is proposed, the process comprising the steps of transporting a plurality of trays holding growing plants from a grow room 101 to the processing room 102, the plurality of trays being stacked on multiple layers of vertical shelves 104 located in the grow room 101, transplanting the growing plants from densely packed trays transported from the grow room to less densely packed trays in comparison with the densely packed tray in the processing room; and transporting the transplanted plants back to the grow room in the less densely packed trays to continue growing until the transplanted plants outgrow the less densely packed trays, subsequent to which the plurality of trays are transported back to the processing room 102 for another round of transplantation.

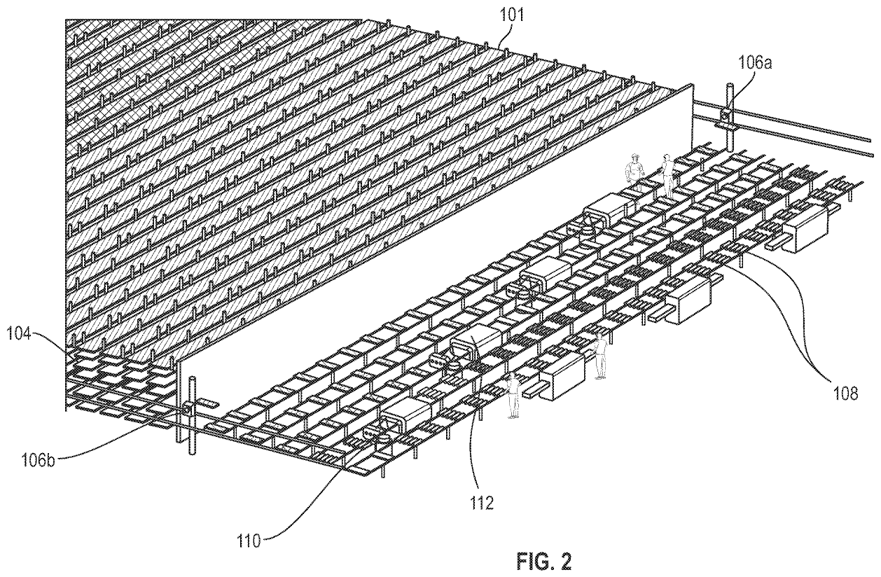

FIG. 2 is a perspective view of the proposed transplantation system 100, in accordance with the present invention.

Considering the structure and working of the articulated robotic arms 110 which assist in the transplanting process—the said arms perform the function of picking up and placing the plants from one tray to another. The functionality of the implemented robotic arms 110, which are positioned in between two conveyor belts (which are continuously transporting trays) 103 is for efficiently transplanting the plants with minimum human intervention, and to avoid the roots 122 from being touched (neither by the robotic arm, nor by the roots of adjacent plants touching each other).

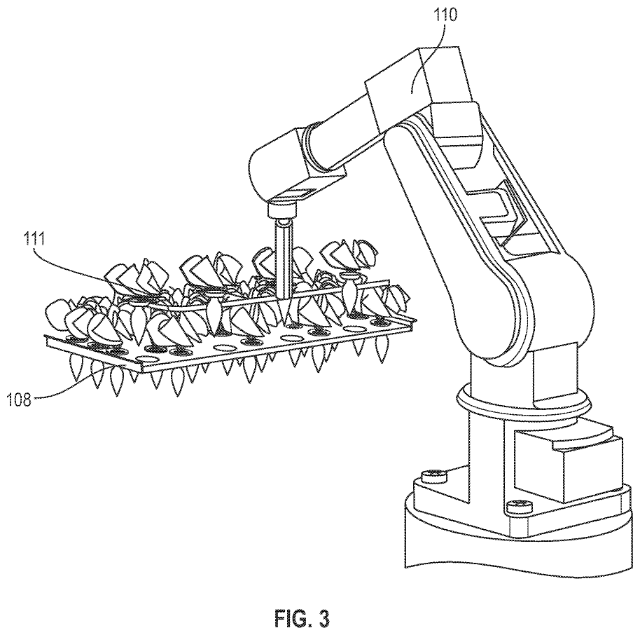

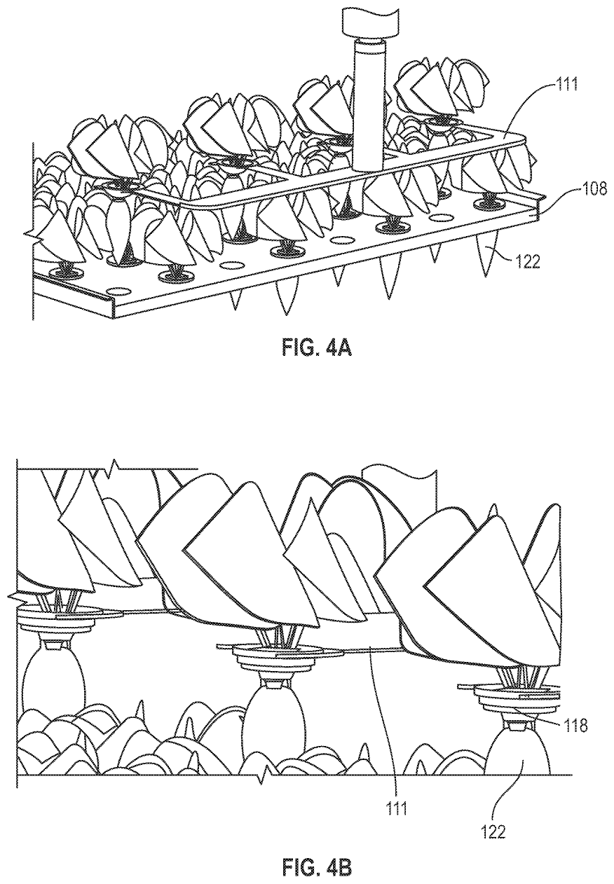

The robotic arms used in accordance with the present invention include a plurality of extensions or fingers (grippers) 111 at the end of the robotic arms (as depicted in FIGS. 3, 4A and 4B) to pick up and place the plants (transplant plants located within holes of the moving trays) from a first tray to a next tray. In another embodiment of the present invention, the articulated robotic arms 110 further include features such as machine vision, and a plurality of sensors for assisting in the process of multiple transplantation. The extensions or fingers 111 located at the end of the articulated robotic arms are programmed and arranged to lift up 2ⁿ plants at a time from the trays 108 (trays wherein the number of holes are in binary multiples, for ease of programming the robotic arms and for ease of picking and placing the plants). The number of the said extensions or fingers 111 are made in such a way so as to be in a multiple of 2 (2ⁿ), so as to allow for simultaneous lifting up of 2ⁿ plants at a time, thereby increasing the efficiency and speed of the whole transplanting process. The articulated robotic arm 110 is capable of moving in a horizontal axis (x axis) direction as well as in a forward direction, so as to lift up plants positioned on the trays 108, 2n plants at a time.

In another embodiment of the present invention, the extensions or fingers 111 (of the articulated robotic arms 110 which assist in the transplanting process) slide under the plants and lift up the plants simultaneously (for example, 4 plants a the same time for transplantation). The said extensions or fingers 111 are designed in such a way that these fit perfectly under the structures holding the plants in the holes of trays 108, and firmly hold the plants during the picking and placing process.

Further, efficient transplanting of plants is achieved in accordance with the present invention, by having a procedure for performing timely transplantation and also ensuring minimum empty spaces between the plants while doing so. The trays filled with plants or seedlings are transported from a grow room (point A) to a processing room (point B) in a continuous fashion—for the transplantation process to take place. After transplanting is done, the emptied trays move through a disinfection area 112 where the emptied trays are cleaned and disinfected before being loaded with new plants or seedlings. The benefits of multiple transplantation of plants include healthier roots, better crop production, stronger and healthier plants. Traditionally implemented systems fail to allow for multiple transplantation without affecting root health, and this problem is effectively solved by the present invention. The present invention aims to achieve effective transplanting of seedlings or plants depending on the rate of growth, and with an aim to avoid any unnecessary empty spaces in between each of the plants on the tray. The reason why empty spaces are avoided in between the plants is to ensure that the growing plants use light efficiently, and to avoid wastage of space or area used for cultivation of the plants or crops. The transplanting procedure includes gradually increases plant spacing throughout the growth cycle with repetitive transplanting procedures.

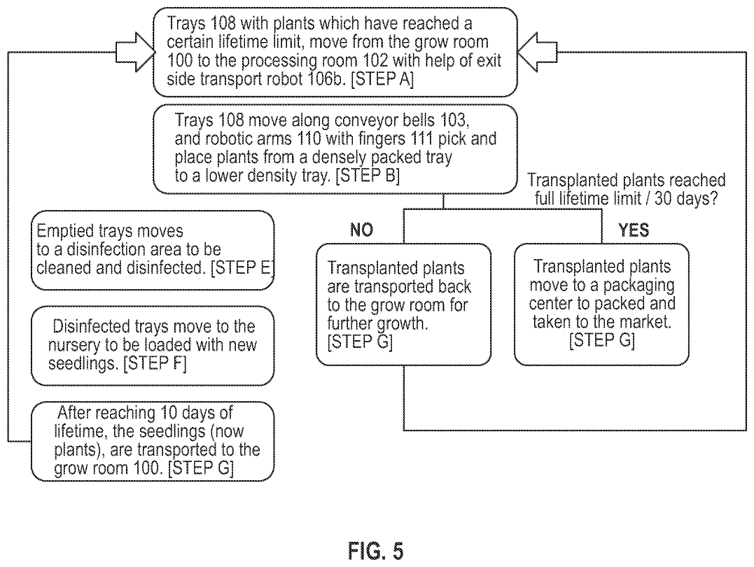

FIG. 5 is a flow chart depicting overall functioning of the articulated robotic arms used for transplantation. As a first step, trays 108 with plants which have reached a certain lifetime limit (for example 10, 20, 25 or 30 days), move from the grow room 101 to the processing room 102, with the help of the exit side transport robot 106b (step A). The trays 108 then move along conveyor belts 103 and the articulated transplantation robotic arms 110 with extensions or fingers 111 pick and place plants from a high density/densely packed tray and move these plants to a less densely packed tray (with holes spaced more apart than the previous tray), thereby transplanting the plants (step B). The transplanted plants are then transported back to the grow room 101 for further growth, in case the plants are not yet fully grown (step C). However, if the transplanted plants have already reached their lifetime limit (30 days in most cases). The tray is then moved to a packaging centre 113, to be packed and sent to the market) or to be further grown outdoors in a crop field or any such open space (step D). The emptied trays (from which plants were moved to less densely packed trays) move towards a disinfection area 112, to be properly cleaned and disinfected (step E). Subsequently, the disinfected trays then move to the nursery area where these disinfected trays are loaded with new seedlings (step F). After these seedlings reach 10 days of their lifetime growth, these are the ready to be taken to the grow room 101 (step G), where the whole process repeats itself for rapid and efficient multiple transplantation of plants. The functionality of the first robotic apparatus 110 is for transplanting the plants with minimum human intervention, and to avoid roots 122 of the plants from being touched.

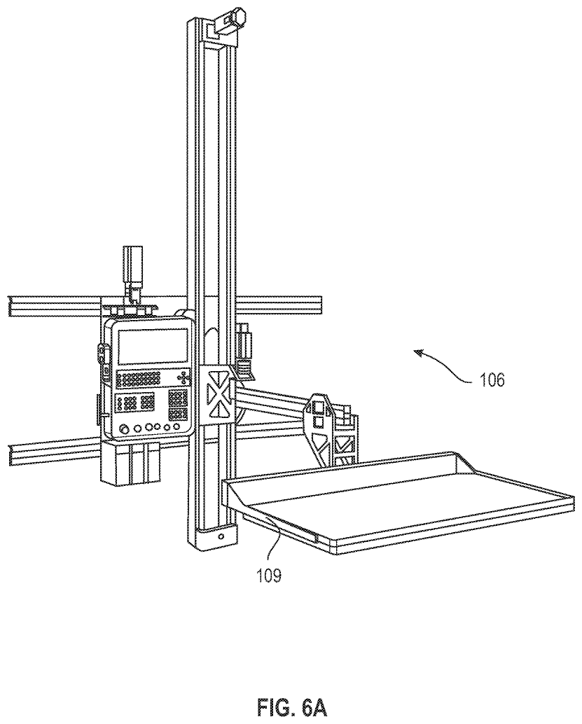

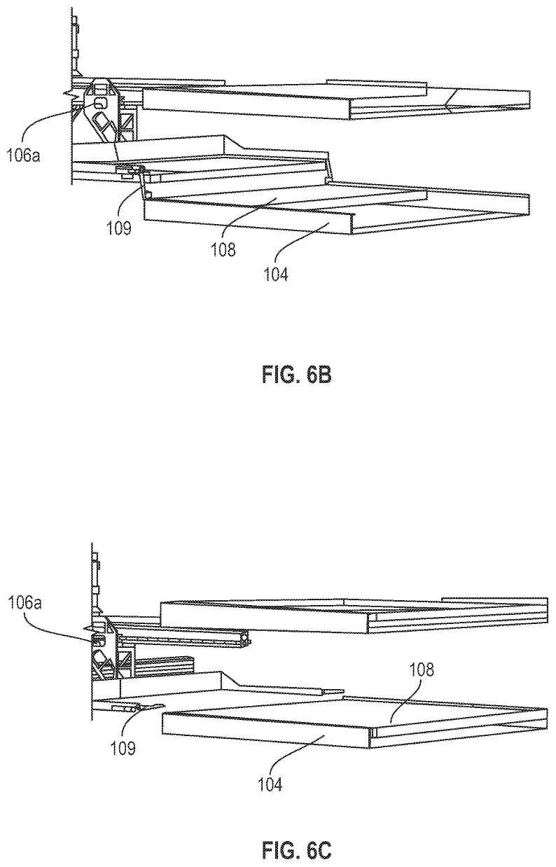

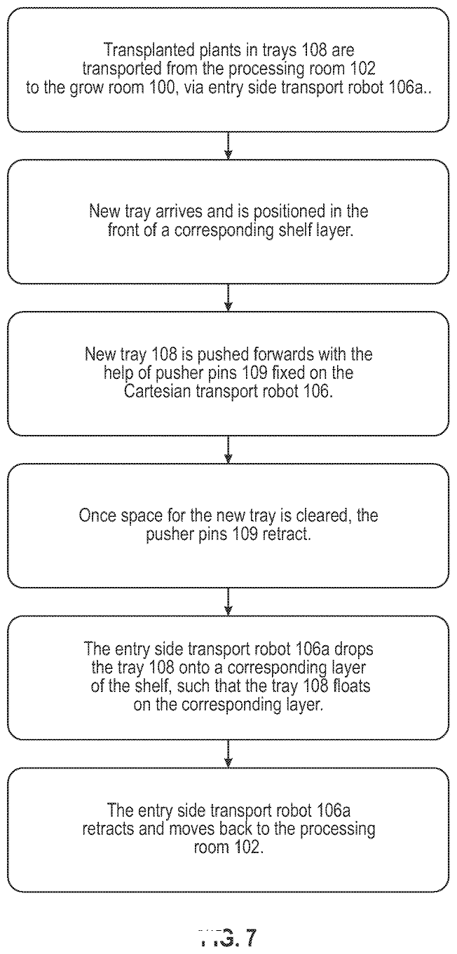

Another aspect of the present invention discloses working of the Cartesian transport robots (entry and exit side robots), as illustrated in FIG. 6A-6C. Cartesian transport robots 106 are used in the grow room 101, operatively positioned on either sides of the vertical shelves 104—specifically an entry side robot 106a and an exit side robot 106b, for carrying and/or transporting the plant trays 108. The Cartesian robotic apparatus in accordance with the present invention is used in the grow room 101 (of the proposed vertical farming system) for picking and placing trays 108 onto and from multiple vertical shelves 104, as well as the process associated with the same. The Cartesian robotic apparatus (or transport robot) 106 is capable of moving along x, y and z axes (so as to have access to each and every tray 108 positioned on the vertical shelves 104), and hence facilitates placing of the trays 108 on the shelves, as well as picking up the trays 108 from the shelves. Trays holding plants or crops come into the grow room from the processing room 102, and are placed on the shelf layers. Subsequently, when it is time for transplanting the grown plants, the trays 108 exit from an output end of the shelf layers and are picked up and transported to the processing room 102 again—via the Cartesian robotic apparatus 106. The Cartesian robotic apparatus 106 performs the procedure of placing down a tray onto the shelf (input), as well as lifting and taking out of a tray from the shelf from the other end (output), which is performed at high speed (approximately 10 m/sec speed).

FIG. 7 is a flow chart depicting functioning of the Cartesian transport robots 106, in accordance with the present invention.

As a first step, transplanted plants in trays 108 are transported from the processing room 102 to the grow room 101, via the entry side transport robot 106a (step A). The entry side robot 106a brings in a new tray and positions the tray in front of a corresponding shelf and layer of the shelf where the tray is to be placed (step B). The new tray 108 is pushed forward towards the respective shelf layer—with the help of pusher pins 109 of the entry side robot (step C). Once sufficient space is obtained for the new tray 108, the pusher pins 109 retract (step D) and the entry side transport robot 106a lowers itself until the tray touches and is positioned or floats on the shelf layer (step E). In another embodiment of the present invention, the pusher pins (the entry side transport robot) facilitate the placing of multiple trays coming from the processing room 102 simultaneously on multiple layers of the vertical shelves 104 in the grow room. The entry side robot in this embodiment has grippers or holding structures which enable multiple trays coming from the processing room to be aligned in front of corresponding shelf layers simultaneously, and pushing these onto the shelf layers using the pusher pins 109.

Once the tray is positioned aptly on the shelf layer, the entry side transport robot retracts back into initial position and moves back to the processing room, to bring in another tray (step F). Functioning of the exit side robot is also similar to the entry side robot. In other words, the main functionality of the entry side transport robot 106a is for pushing and dropping the plant trays 108 onto each layer of the vertical shelf 104, and the main functionality of the exit side transport robot 106b is for pulling the plant trays 108 outwards and assists in transporting the plant trays 108 to the next position (most likely to the processing room). Growing plants are allowed to grow in a controlled environment while being positioned on the plurality of vertical shelves 104, and multiple transplantation of the growing plants occurs in the processing room 102 at a pre-determined stage of the growing plants' lifecycle.

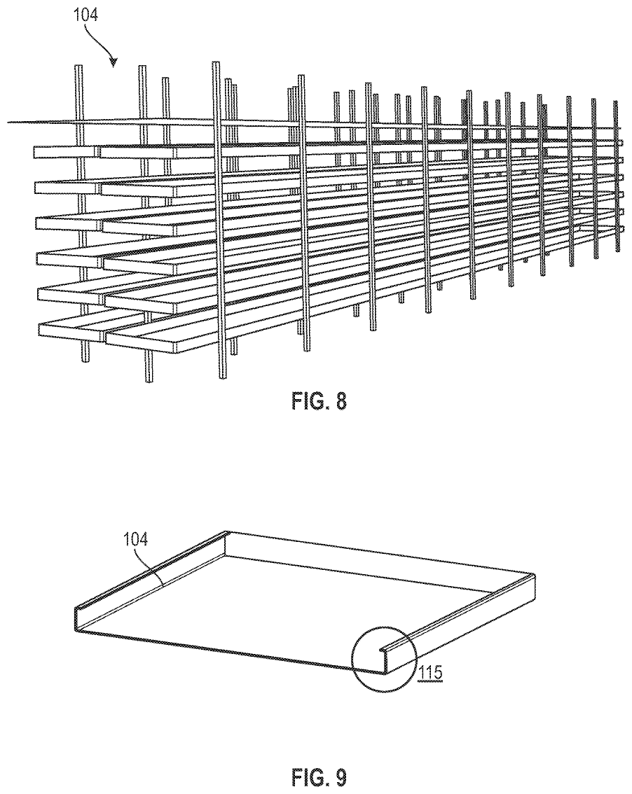

Another aspect of the present invention deals with a plurality of specialized vertical shelves 104 with multiple layers for vertical farming (as shown in FIG. 8), wherein the structure of the vertical shelves 104 with layers is used in the grow room 101 for storing/holding different types of plants held within trays 108. The layers of the said shelves 104 holding a plurality of trays 108, employ a ‘floating raft technique’ for holding the said trays 108—wherein each of the layers of the vertical shelves 104 are filled with a liquid (water or hydroponic nutrient solution), such that the trays 108 when placed onto the shelf layers (via the transport robot 106), float on the shelf layers. This floating of the trays 108 enables ease of pushing and moving a whole row of trays placed on each layer of the vertical shelves 104. Accordingly, when the vertical shelf layers are filled with water, it is easy to move the whole set of trays positioned on a particular layer of the shelf, by merely pushing a tray positioned at the beginning of the row (which will lead to pushing of all other trays positioned on that particular row of the shelf), thereby acting as a passive conveyor for the trays 108.

In another embodiment, the proposed shelves have a plurality of vertical layers, and also exist as double shelves. Also, the type or arrangement of shelf layers differ or are adjusted, based on the type of plant/vegetable being grown (shelf layers or modules are designed per produce).

In another embodiment of the present invention, each of the shelf layers are shaped in such a way so as to be able to (or have sufficient space to) hold water within the layer. Further, each of the shelf layers have a curvature or C shaped portion 115 at the upper portion of the shelf layers, to allow for the trays 108 to be placed well on each of the shelf layers, as indicated in FIG. 9. Dimensions of each of the shelf layer is approximately 1030×70 cm, the C shaped portion having a length of 15 cm.

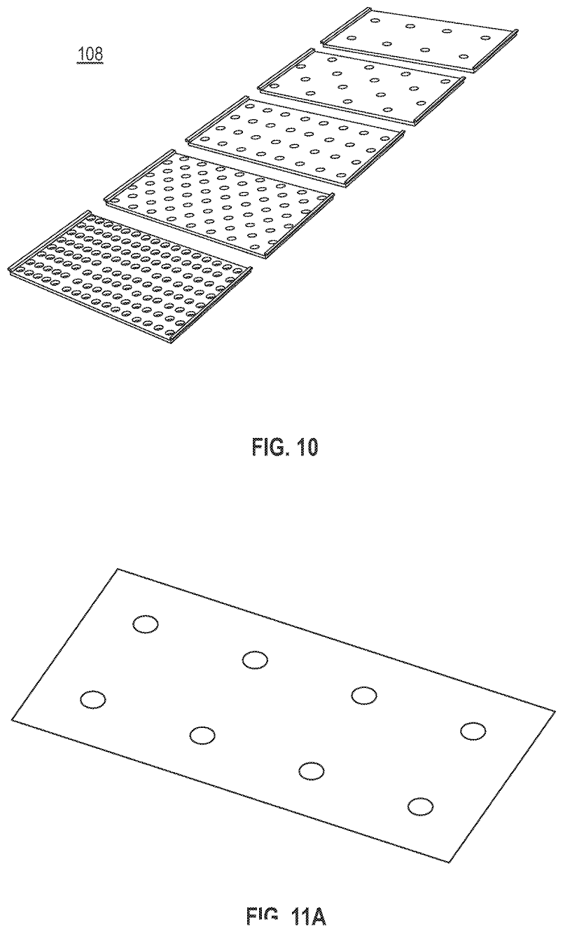

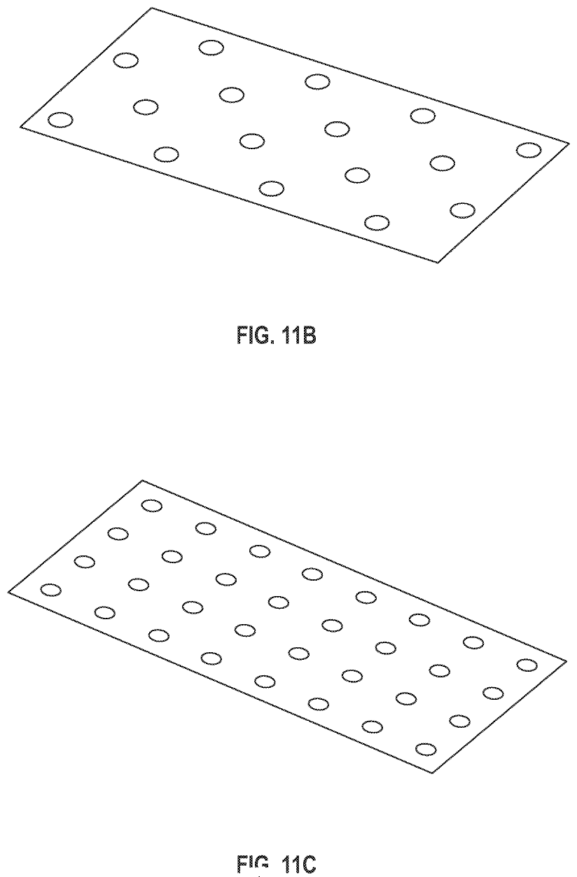

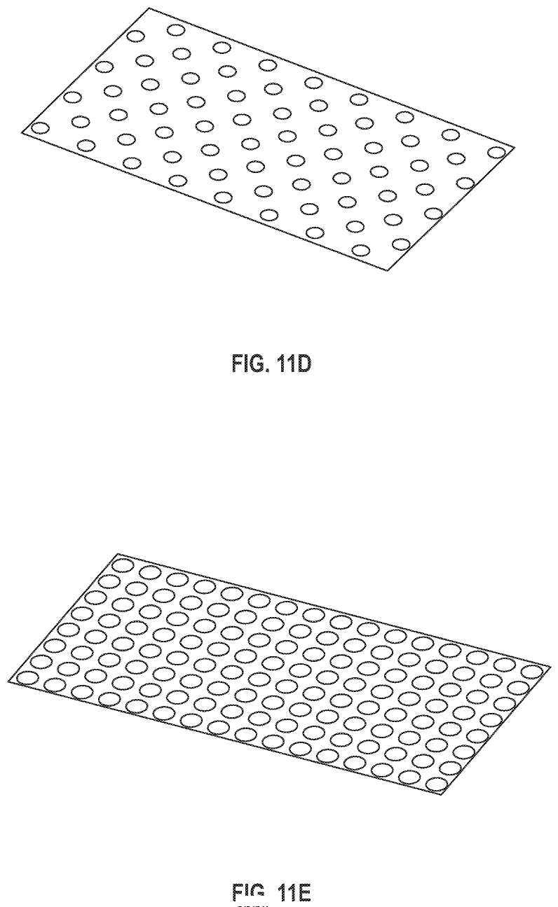

Another aspect of the proposed invention deals with specialized trays 104 with cups for plant transplantation, for storing/holding a plurality of seedlings, plants, or crops, and the trays 104 comprising a plurality of holes are used to accommodate seedlings or plants within these holes. The proposed structures (of the trays) assist in increasing overall crop yield and for growing healthier produce. FIG. 10 shows the trays 108 in accordance with the present invention with holes in varying numbers/densities (however preferably in multiples of 4). FIG. 11 shows a tray with 16 holes per m² (FIG. 11A), a tray with 32 holes per m² (FIG. 11B), a tray with 64 holes per m² (FIG. 11C), a tray with 128 holes per m² (FIG. 11D) and a tray with 256 holes per m² (FIG. 11E). In an embodiment, each of the holes are spaced apart at a distance of 250 cm from each other, and each of the holes has a diameter of 50 cm. An overall dimension of each of the trays used is approximately 990×500 cm.

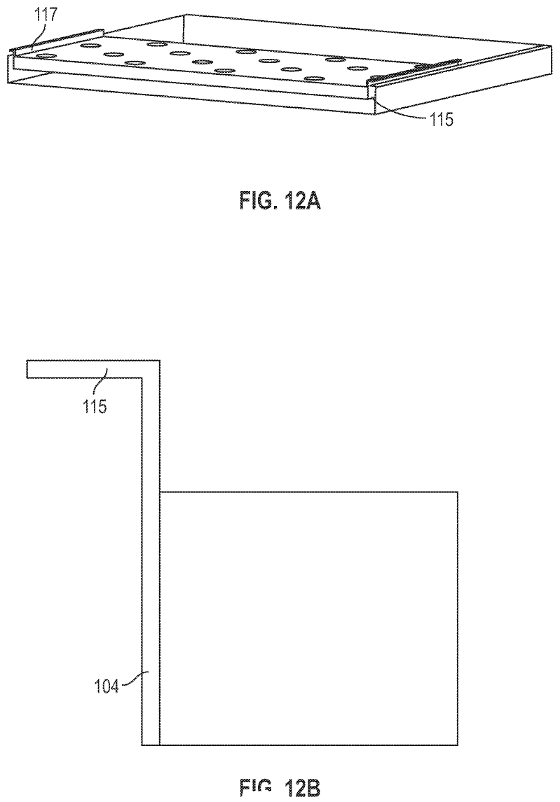

FIG. 12 clearly depicts how each tray 108 is placed aptly on each of the vertical shelf layers, with the help of the curvature or C shaped portion 115 at the upper portion of the shelf layers, as well as owing to an extension portion 117 present on either sides of the trays 108 (which helps in easy placement of the trays 108 on the shelf layers). Owing to this shape of the shelf layers and of the trays, the trays 108 are easily placed, and lifted off the shelves via the transport robot 106—without touching the plants or roots 122, and with minimum human intervention (to avoid the roots 122 from being touched neither by the robotic arm, nor by the roots 122 of adjacent plants touching each other). In another embodiment of the present invention, the trays (sustainable and single sheet) 108 are manufactured from materials such as aluminium (preferable) or plastic. Metal or aluminium trays are more preferable to enable efficient cleaning (or sanitization) and disinfection (heat) treatments to the trays, considering the process wherein the emptied trays (from which plants were moved to less densely packed trays) during transplantation, move towards a disinfection area 112, to be properly cleaned and disinfected (prior to being reloaded with new seedlings). As per market standards, styrofoam or blow-molded plastic sheets are used for making trays in accordance with the present invention, however aluminum trays are preferred, as once pressed to a flat form, these aluminium trays facilitate floating. In addition to this, these trays have a long lifetime, are sturdy and easy to handle, are stackable and 100% recyclable. Overall, these trays are easy to disinfect without chemicals, by applying hot steam methods.

Another feature of the proposed trays 108 include having anti-bacterial or anti-algae formation properties. This is implemented by enabling a back portion or backside of the trays to be blackened out, to block out any light or optical energy from the gap between the shelf layer and the tray, thereby eliminating the formation of algae or any kind of bacteria. Further, in addition to the blackening out of the backside of the trays 108, the particular and apt placement of the tray 108 on the shelf layers (with the help of the curvature or C shaped portion 115 at the upper portion of the shelf layers, as well as owing to an extension portion 117 present on either sides of the trays 108), also assists in blocking out any light or optical energy from the gap between the shelf layer and the tray.

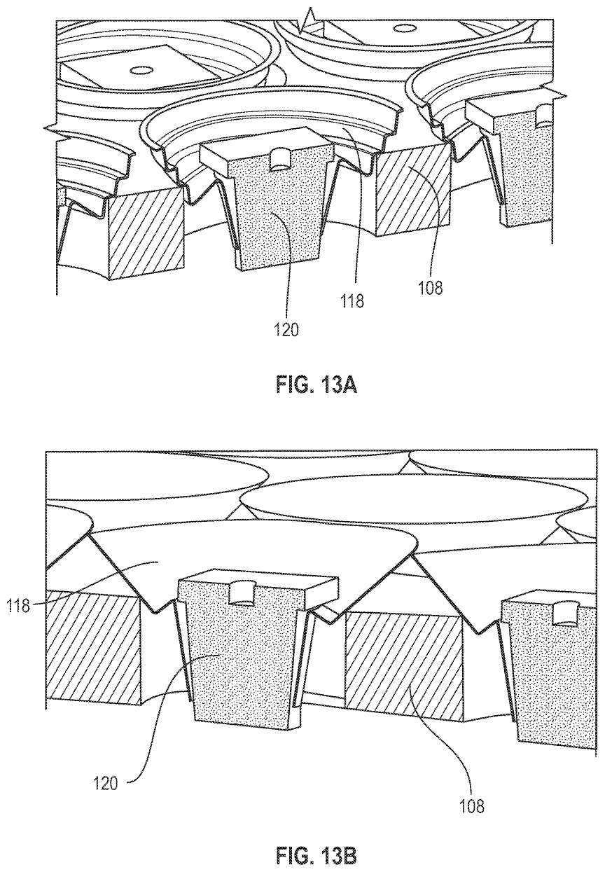

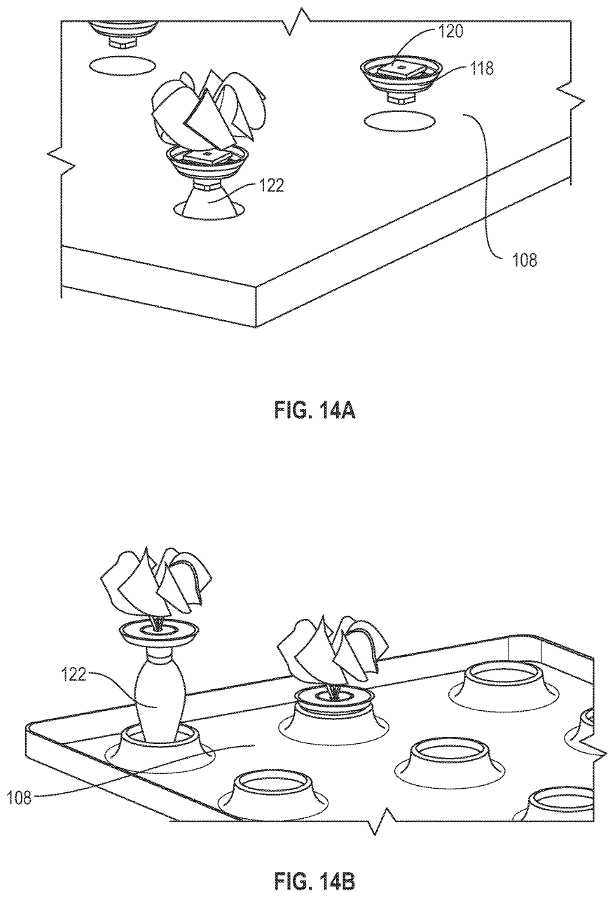

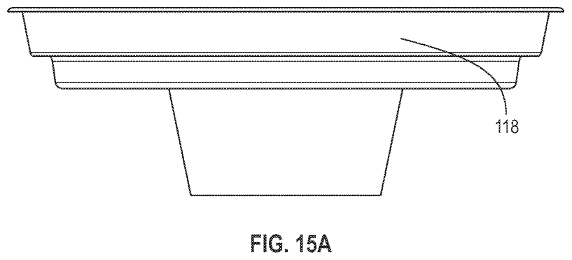

Another objective of the present invention is to enable an effective vertical farming technique by using the proposed trays 108 in accordance with the present invention having a plurality of holes to accommodate seedlings or plants within these holes. As depicted in FIGS. 13A, 13B, 14A and 14B, the seedlings or plants are placed within cups 118 and rooted within an insulation material 120, such as rockwool or a sponge, with the roots immersed in the nutrient solution filled up at a bottom area of the trays 108, or in the shelf layers. Accordingly, the present invention also helps to achieve efficient transplanting of seedlings or plants (for example from a 256 hole tray to a 128 hole tray, followed by transplanting to a 64, 32, 16 and 8 hole tray—as the plants grow bigger and wider) and to ensure equal spacing between all plants and minimum empty spaces between the plants. The plurality of holes of the trays used in the present invention is numbered in binary multiples, for ease of programming the robotic arms. The holes on the trays (any shape, however preferably circular) are also large enough so as to not agitate the plant or plant roots 122. The seedlings or plants are allowed ample space and growth time, by having the seedlings or plants grow in direct contact with a nutrient solution whilst being positioned within holes of the trays 108—however, by avoiding any wastage of space between the plants. This process occurs within a specialized area termed as the grow room 101.

Considering the special cups 118 in accordance with the present invention, the proposed cups have at least two layers or rings to enable height adjustment of the plants placed in the cups. Accordingly, the size and design of the cups used in the tray enable adjustment of the height of the plants placed in the cups, and thereby decide the amount of roots 122 which need to be touching or immersed within the nutrient solution (for example immerse 75% of roots in the nutrient solution/only root tips to touch in the nutrient solution). In another embodiment, cups without any layers or rings (FIG. 13B) may also be used to hold plants on the trays. These cups are conical in shape (and non-layered).

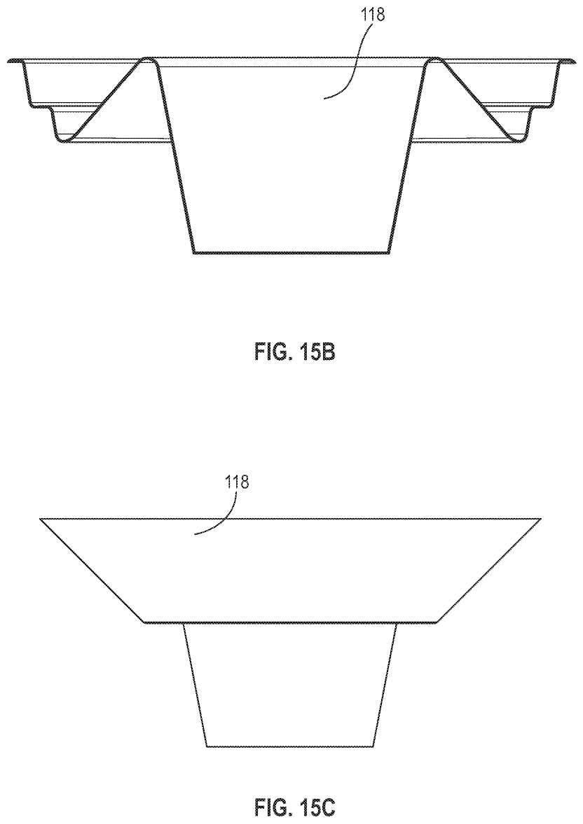

In another embodiment of the present invention, the extensions or fingers 111 (of the articulated robotic arms 110 which assist in the transplanting process) slide under the cups 118 holding the plants and lift up the plants simultaneously (for example, 4 plants a the same time for transplantation). The said extensions or fingers 111 are designed in such a way that these fit perfectly under the stepped layers of the cups when slid underneath the cups 118, and firmly hold the cups (owing to the various stepped layers) during the picking and placing process. Another advantage of the stepped layers is that the cups 118 will be firmly held even if the dimensions of the said extensions or fingers 111 are slightly increased or decreased, by holding onto either an upper layer, if gap between the extensions are smaller and by holding onto a lower layer, if the gap between the extensions are greater. FIG. 15A-C show three different types of cups used for the seedlings or plants in the trays 108—particularly a cup holder with multiple straight layers (FIG. 15A), a cup holder with multiple layers and grooves (FIG. 15B) for easy placement of the cup within the holes of the trays and for easy placement of the insulation material 120, and a cup holder without any layers (FIG. 15C).

Many changes, modifications, variations and other uses and applications of the subject invention will become apparent to those skilled in the art after considering this specification and the accompanying drawings, which disclose the preferred embodiments thereof. All such changes, modifications, variations and other uses and applications, which do not depart from the spirit and scope of the invention, are deemed to be covered by the invention, which is to be limited only by the claims, which follow.

1. A plant multiple transplantation process, the process comprising the steps of:
transporting a plurality of trays holding growing plants from a grow room to a processing room, the plurality of trays being stacked on multiple layers of vertical shelves located in the grow room;
transplanting the growing plants from densely packed trays transported from the grow room to less densely packed trays in comparison with the densely packed tray in the processing room; and
transporting the transplanted plants back to the grow room in the less densely packed trays to continue growing until the transplanted plants outgrow the less densely packed trays, subsequent to which the plurality of trays are transported back to the processing room for another round of transplantation.

2. The plant multiple transplantation process of claim 1, wherein transplanting the growing plants from the densely packed trays arriving from the grow room comprises:
emptying the densely packed trays and moving the growing plants to the less densely packed trays; and
disinfecting the emptied trays prior to reloading with new seedlings or plants.

3. The plant multiple transplantation process of claim 2, wherein disinfecting the emptied trays comprises cleaning and disinfecting the emptied trays, which is performed at a disinfection area in the processing room.

4. The plant multiple transplantation process of claim 3, further comprising transporting the cleaned emptied trays to a nursery area; and loading the cleaned emptied trays with new seedlings.

5. The plant multiple transplantation process of claim 1, wherein an entry side transport robot facilitates placing of the plurality of trays coming from the processing room on the plurality of vertical shelves in the grow room, and an exit side transport robot facilitates picking up of the plurality of trays from the plurality of vertical shelves in the grow room to the processing room for transplantation.

6. The plant multiple transplantation process of claim 5, wherein the entry side and exit side transport robots are Cartesian robots which move along x and y-axes.

7. The plant multiple transplantation process of claim 1, wherein growing plants which reach full growth or a 35-day lifetime are transported to a packaging center to be packed and sent to market, or to be further grown outdoors in a crop field or open space, instead of being transported back to the grow room.

8. The plant multiple transplantation process of claim 1, wherein the growing plants are positioned within holes of the plurality of trays, with minimum empty spaces between the growing plants for achieving optical efficiency and for adequate area utilization.

9. The plant multiple transplantation process of claim 8, wherein each of the growing plants are positioned within holes of the plurality of trays such that roots of the growing plants are constantly in direct contact with a film of liquid present at a bottom of the plurality of trays.

10. The plant multiple transplantation process of claim 9, wherein the liquid is water or a nutrient solution.

11. The plant multiple transplantation process of claim 8, wherein the plurality of trays comprise 16 holes per m2, 32 holes per m2, 64 holes per m2, 128 holes per m2 or 256 holes per m2.

12. The plant multiple transplantation process of claim 1, wherein transplanting the growing plants from densely packed trays to less densely packed trays in comparison with the densely packed tray is done using at least one robotic arm and at least two conveyor belts positioned in the processing room.

13. A plant multiple transplantation system comprising:
a first robotic apparatus positioned in a processing room, for picking up and placing growing plants from densely packed trays arriving from a grow room to less densely packed trays in comparison to the densely packed trays for transplantation of the said plants; and
a second robotic apparatus positioned in the growth room, for placing of the less densely packed trays comprising transplanted plants coming from the processing room in the grow room, and for picking up of the trays from the grow room to the processing room for further transplantation, once the transplanted plants outgrow the less densely packed trays.

14. The plant multiple transplantation system of claim 13, wherein the first robotic apparatus is an articulated robotic arm.

15. The plant multiple transplantation system of claim 13, wherein the second robotic apparatus is a Cartesian transport robot.

16. The plant multiple transplantation system of claim 13, wherein transplanting the growing plants from densely packed trays to less densely packed trays in comparison with the densely packed tray is done using at least one robotic arm and at least two conveyor belts positioned in the processing room.

17. The plant multiple transplantation system of claim 13 further comprising, emptying the densely packed trays by moving the growing plants to the less densely packed trays; and a disinfection area for disinfecting the emptied trays prior to reloading with new seedlings.

18. The plant multiple transplantation system of claim 17, further comprising a nursery where the cleaned emptied trays are transported to; for loading the cleaned emptied trays with new seedlings.

19. The plant multiple transplantation system of claim 13, wherein trays filled with growing plants are transported from the grow room to the processing room, and vice-versa in a continuous fashion for multiple transplantation to be done.

20. The plant multiple transplantation system of claim 13, wherein the trays filled with growing plants are positioned on a plurality of vertical shelves located in the grow room, until a next round of transplantation is required.
